(19) United States
(12) Patent Application Publication
(10) Pub. No.: US 2018/0307474 A1
(43) Pub. Date: Oct. 25, 2018

(54) FIRMWARE UPDATE IN A STACKED NETWORK DEVICE

(71) Applicant: Hewlett Packard Enterprise Development LP, Houston, TX (US)

(72) Inventors: Sandesh V. Madhyastha, Bangalore (IN); Vijay Chakravarthy Gilakala, Bangalore (IN); Harish B. Kamath, Bangalore (IN); Ravindhar Uppada, Bangalore (IN); Muralidhar Hadamagere Venkataramu, Bangalore (IN)

(21) Appl. No.: 15/619,678

(22) Filed: Jun. 12, 2017

(30) Foreign Application Priority Data
Apr. 19, 2017 (IN) 201741013924

(51) Int. Cl. G06F 9/445

(52) U.S. Cl. CPC G06F 8/65; G06F 8/71; G06F 8/665

(57) ABSTRACT

Examples disclosed herein relate to a plying a firmware update to a stacked network device. In an example, ports on a stacked network device that are used in a data path between an uplink device and a downlink device via the stacked network device may be identified. The stacked network device may be in a stacked configuration with a second network device. Each of the identified ports on the network device may be in respective link aggregation groups with respective ports on the second network device, LACP collecting flag for the ports on the stacked network device may be disabled. The egress traffic on the ports of the stacked network device may be drained. The data path may be disabled. A firmware update may be applied to the stacked network device.

### BACKGROUND

Computer networks form the foundation of an organization's information technology (IT) infrastructure. Considering their importance, computer networks are expected to have high availability and scalability. A stacking system may be useful in this regard. In a stacking system, two or more network devices (for example, network switches) may be connected to one another via cables, to form a single logical network device. Network devices may he added to and removed from a stack without affecting network performance.

### BRIEF DESCRIPTION OF THE DRAWINGS

For a better understanding of the solution, embodiments will now be described, purely by way of example, with reference to the accompanying drawings, in which:

FIG. 1 is a block diagram of an example computing environment for performing a firmware update in a stacked network device:

FIG. 2 is a diagram of an example system for performing update in a stacked network device;

FIG. 3 is a block diagram of an example method of performing a firmware update in a stacked network device; and

FIG. 4 is a block diagram of an example system including instructions in a machine-readable storage medium for performing a firmware update in a stacked network device.

### DETAILED DESCRIPTION

A typical network may contain various network elements, for example, routers, switches, load balancers, etc. The network connecting the network elements may be used to provide secure access to data and various computing resources, for example, applications, and storage. A robust network infrastructure may protect applications and services from downtime. In this regard, updates to the firmware of network devices (for example, network switches, routers, etc.) may be carried out to achieve improved performance, security, and reliability. It may be desirable to perform these firmware updates in a manner that minimizes network disruptions and interruption to the applications dependent thereon.

To address these issues, the present disclosure describes various examples for applying a firmware update to a stacked network device, which may minimize network disruptions, in an example, ports on a stacked network device that are used in a data path between an uplink device and a downlink device via the stacked network device may be identified. The stacked network device may be in a stacked configuration with a second network device. Each of the identified ports on the network device may be in respective link aggregation groups with respective ports on the second network device. In an example, the stacked network device may be placed in a maintenance state. In the maintenance state, link Aggregation Control Protocol (LACP) collecting flag for the ports on the stacked network device may be disabled. The egress traffic on the ports of the stacked network device may be drained. The data path may be disabled. A firmware update may be applied to the stacked network device. During the firmware update, data traffic on the data path may be switched to an alternate data path through the respective ports on the second network device that are in respective link aggregation groups.

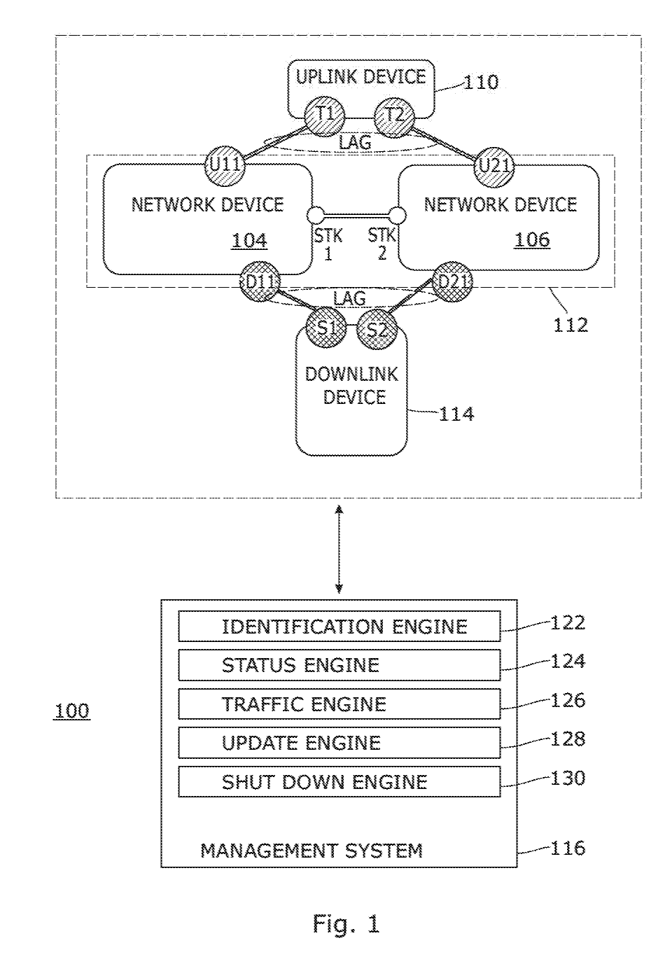

FIG. 1 is a diagram of an example computing environment 100 for performing a firmware update in a stacked network device. Computing environment 100 may include an uplink device 110, a stacking system 112, a downlink device 114, and a management system 116.

In an example, uplink device 110 may be a network device, for example, a network switch, a router, a virtual switch, or any other network device that is capable of performing switching functions and/or routing functions. In an example, uplink device may be a top-of-rack (TOR) switch. In an example, uplink device 110 may be in a stacked state.

In an example, downlink device 114 may be a computing device capable of reading machine-executable instructions. Examples of the computing device may include, without limitation, a server, a blade server, a desktop computer, a notebook computer, a tablet computer, a thin client, a mobile device, a personal digital assistant (FDA), and the like.

In an example, stacking system 112 may comprise a plurality of network devices. Referring to FIG. 1, stacking system 112 may include network devices 104 and 106. Although two network devices are shown in FIG. 1, other examples of this disclosure may include more than two network devices.

Network devices 104 and 106 may be communicatively coupled to one another via one or more cables. Network devices 104 and 106 may be arranged in system 112 through various types of network topologies, for example, a ring topology, or a daisy-chain topology which provides redundancy for the configured networks.

Network devices 104 and 106 may each be, for example, a network switch, a router, or any other network device that is capable of performing switching and/or routing-related functions. In an example, network devices 104 and 106 may include network switches that are line card parts of a chassis. Network devices 104 and 106 may be communicatively coupled to one another to form a single logical network device. Each of the network devices 104 and 106 in system 112 may share configuration and routing information so that network devices 104 and 106 may appear as a single network unit to an external device (for example, uplink device).

In an example, network devices 104 and 106 may each be a virtual connect device. A virtual connect device may virtualize servers (for example, blade servers) which may be arranged in an enclosure. A virtual connect device may add an abstraction layer between the edge of a server and the edge of a network fabric. As a result, the external networks connect to a shared resource pool of MAC addresses and WWNs, rather than to MACs/WWNs of individual servers. Using the concept of a “server profile,” a virtual connect device links information assigned to a specific server bay to the server hardware and its network connections. A server profile may be used to manage a server's internal identity (server serial number, UUID, BIOS settings, SAN boot parameters, and PXE boot parameters) and a server's external identity (MACs, WWNs, VLAN assignments, and SAN fabric assignments). In an example, a virtual connect may be managed via management system 116.

Stacking system 112 may be communicatively coupled to uplink device 110 and downlink device 114. In an example, each network device (104 and 106) of stacking system may be individually linked to uplink device.

In an example, link aggregation may be used on the links between network devices (104 and 106) and uplink device, and between network devices (104 and 106) and downlink device. Link aggregation may be defined as a process of inter-connecting two devices with two or more links between them, so that multiple links may be combined into one bigger virtual link that may carry a higher bandwidth and also provide redundancy when one of the links fail. A Link Aggregation Group (LAG) may combine a number of physical or virtual ports (for example, on network devices 104 and 106) together to make a single high-bandwidth data path. Referring to FIG. 1, link aggregation may be created between network devices (104 and 106) and uplink device (for example, a TOR switch). In an example, link aggregation may be created using ports U11 (on network device 104), U21 (on network device 106), T1 (on uplink device), and T2 (on uplink device) in active/active or active/passive mode of the Link Aggregation Control Protocol (LACP). Link aggregation may be created between network devices (104 and 106), and downlink device. In an example, link aggregation may be created using ports D11 (on network device 104), D21 (on network device 106), S1 (on downlink device 106), and S2 (on downlink device 106) in active/active or active/passive mode of the Link Aggregation Control Protocol (LACP).

LACP provides a method to control the bundling of several physical ports together to form a single channel. LACP allows a network device to negotiate an automatic bundling of links by sending LACP packets to the peer (directly connected device that also implements LACP).

In “active mode”, when a port is enabled for link aggregation, the port may exchange standard LACP Protocol Data Unit (LACPDU) messages to negotiate trunk group configuration with the port on the other side of the link. In addition, the port may actively send LACPDU messages on the link to search for a link aggregation partner at the other end of the link, and can initiate an LACPDU exchange to negotiate link aggregation parameters with an appropriately configured remote port.

As mentioned earlier, network devices 104 and 106 may be part of a stacking system. Stacking system or architecture may include one or more network devices (for example, network switches) that may be connected to one another via one or more cables, to form a single logical network device. Configuration and routing information shared by every network device in stacking system so that multiple network devices appear as a single network unit to an external component. All stack members may have complete access to the stacking backplane (for example, connections between stacked units, and interconnect bandwidth). Network topology and routing information may be regularly updated among the stack network devices. Thus, from the perspective of a management plane and a data plane, the “stacked switches” may operate as a single virtual switch.

In an example, network devices 104 and 106 in stacking system 112 may be communicatively coupled via one or more stacking ports (for example, STK1 and STK2).

In an example, data traffic passing through a port (for example, T1) of uplink device to an aggregate port on downlink device via stacking system 112 may take either of the following paths: 1) T1-U11-D11-S1, and 2) T1-U11-STK1-STK2-D21-S2. Similarly data traffic passing through, another port (for example, T2) of uplink device to an aggregate port on downlink device via stacking system 112 may take either of the following paths: 1) T2 -U21-D21-S2, and 2) T2 -U21-STK2-STK1-D11-S1.

In an example, management system 116 may be a computing device capable of reading machine-executable instructions. Examples of the computing device may include, without limitation, a server, a blade server, a desktop computer, a notebook computer, a tablet computer, a thin client, a mobile device, a personal digital assistant (FDA), and the like. In an example, management system 116 may be used to bring a stacked network device (for example, 104 and 06) to a fail-safe state. A network device may be in a “fail-safe state” when there are no packets in link aggregation ports (LAG ports) of the device in the sucked environment. It an example, management system 116 may be used to bring a stacked network device (for example, 104 and 106) to a fail-safe gate by managing data traffic to the network device, and the packets in the ingress and egress queue of respective ports on the network device.

Management system 116 may be in communication with stacking system 112, for example, via a computer network. In an instance, the network may be a Local Area Network (LAN), a Wireless Local Area Network (WAN), a Metropolitan Area, Network (MAN), a public network (for example, the Internet) or a private network (for example, an intranet).

In an example, management system 116 may include an identification engine a status engine 124, a traffic engine 126, an update engine 128, and a shutdown engine 130.

Engines 122, 124, 126, 126, and 130 may include any combination of hardware and programming to implement the functionalities of the engines described herein. In examples described herein, such combinations of hardware and software may be implemented in a number of different ways. For example, the programming for the engines may be processor executable instructions stored on at least one non-transitory machine-readable storage medium and the hardware for the engines may include at least one processing resource to execute those instructions. In some examples, the hardware may also include other electronic circuitry to at least partially implement at east one engine of management system 116. In some examples, the at least one machine-readable storage medium may store instructions that, when executed by the at least one processing resource, at least partially implement some or all engines of management system 116. In such examples, management system may include the at least one machine-readable storage medium storing the instructions and the at least one processing resource to execute the instructions.

Identification engine 122 may identify ports (for example, physical ports and/or virtual ports) on a stacked network device (for example, 104) that are used in a data path between an uplink device (for example, 110) and a downlink device (for example, 114) via stacked network device 104. Stacked network device 104 may be part of a stacking system (for example, 112, and may be in a stacked configuration with a second network device (for example, 105). In an example, stacking system 112 may include n number of network devices, and stacked network device 104 may be in a stacked configuration with n number of network devices. In an example, the ports identified by identification engine 122 may include ports that are in respective link aggregation groups with respective ports (for example, physical ports and/or virtual ports) on second network device. Referring to FIG. 1, as mentioned earlier, in an example, link aggregation may be created using ports U11 (on network device 104), U21 (on network device 106), T1 (on uplink device), and T2 (on uplink device). Link aggregation may be created using ports D11 (on network device 104) D21 (on network device 106), S1 (on downlink device 106), and S2 (on downlink device 105). In this example context, identification engine 122 may identify ports U11 and D11 on network device 104 that form link aggregation groups with ports (U21 and D21) on second network device 106.

In an example, identification engine 122 may be stacked network device in a maintenance state. In an example, in the maintenance state, status engine 124 may disable Link Aggregation Control Protocol (LACP) collecting flag for the identified ports (for example, U11 and D11) on stacked network device 104. A LACP collecting flag for a port/interface is set to indicate that the port is not in a state to receive data traffic on this interface of the device (for example, 104). For example, if collecting flag for a port is set to a “TRUE” state, any data traffic received on the link will be collected and delivered to the user of the aggregate port. If collecting flag for the port is set to disabled status (for example, a “FALSE” state) on a device port (for example, U11 of device 104), the data traffic from uplink device (for example, from T1 on device 110) may not be distributed as the receiving port (U11 of device 104) is not ready to collect the data traffic. In the context of the earlier example, once status engine 124 disables LACP collecting flag for the identified ports for example, U11 and D11) on stacked network device 104, data traffic, from uplink device 110 being received on the identified ports will be switched over to other ports (for example, U21) in the link aggregation. In an example, once the LACP collecting flag for the identified ports has been disabled, status engine 124 may store the collecting flag disabled state for the identified ports, for example, in a configuration file. In an example, the configuration file may be stored on stacked network device 104.

Disabling the LACP collecting flag for the identified ports may stop incoming traffic on uplink (U11) and downlink (D11) ports of data path belonging to stacked network device 104. Traffic engine 126 may disable traffic into a local port of stacked network device 104 from second network device 106 via a stacking link for example, via port STK1).

Traffic engine 126 may drain egress traffic on the identified ports (for example, U11 and D11) of stacked network device. Traffic engine 126 may also disable the data path between uplink device and downlink device via stacked network device 104. In the context of the earlier example, traffic on data path T1-U11-D11-S1 may switch over to an alternate data path. In an example, once the data path via stacked network device 104 has been switched over, data traffic on the data path may be switched to an alternate data path through the respective ports that are in respective link aggregation groups on second network device 106. In the context of the earlier example, once data path (T1U11-D11-S1) has switched over, data traffic may be switched to an alternate data path, for example. T2-U21-D21-S2, via second network device 106.

In the maintenance state, update engine 128 may apply a firmware update to stacked network device 104. During the firmware update, data traffic may flow through the alternate data path, for example, T2-U21-D21-S2, via second network device 106.

Once the firmware update is complete, stacked network device 104 may be shut down. Shutdown engine 130 may send, for example, a shutdown event to shut down stacked network device 104. In an example, stacked network device 104 may be rebooted once the firmware update is complete. In such case, when a reboot of stacked network switch is initiated, the collecting flag disabled state for the identified ports that were stored earlier (for example, in a configuration file) may be read, and the LACP collecting flag for the identified ports on stacked network switch are maintained in a disabled state during the reboot. Once the reboot of stacked network device 104 is complete, LACP collecting flag for the identified ports may be enabled on stacked network device 104.

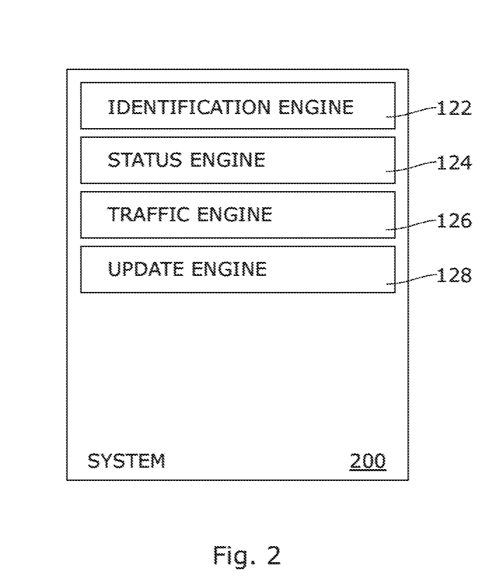

FIG. 2 is a block diagram of an example system 200 for performing a firmware update in a stacked network device. In an example, system 200 may be analogous to management system 116 of FIG. 1, in which like reference numerals correspond to the same or similar, though perhaps not identical, components. For the sake of brevity, components or reference numerals of FIG. 2 having a same or similarly described function in FIG. 1 are not being described m connection with FIG. 2. Said components or reference numerals may be considered alike.

System 200 may be a computing device capable of reading machine-executable instructions. Examples of the computing device, may include, without limitation, a server, a blade server, a desktop computer, a notebook computer, a tablet computer, a thin client, a mobile device, a personal digital assistant (PDA), and the like. In an example, system 200 may include an identification engine 122, a status engine 124, a traffic engine 126, and update engine 128.

In an example, identification engine 122 may identify ports on a stacked network switch that are used in a data path between an uplink device and a downlink device via the stacked network switch. The stacked network switch may be in a stacked configuration with a second network switch. Each of the ports may be in respective link aggregation groups with respective ports on the second network switch. Identification engine 122 may place the stacked network in a maintenance state. In an example, in the maintenance state, status engine 124 may disable Link Aggregation. Control Protocol (LACP) collecting flag for the ports on the stacked network switch. Traffic engine 126 may drain egress traffic on the ports of the stacked network switch. Traffic engine 126 may disable traffic into a local port of stacked network device. Update engine 128 may apply a firmware update to the stacked network switch in the maintenance state. In an example, during the firmware update, data traffic on the data path may be switched to an alternate data path through the respective ports that are in respective link aggregation groups on the second network switch.

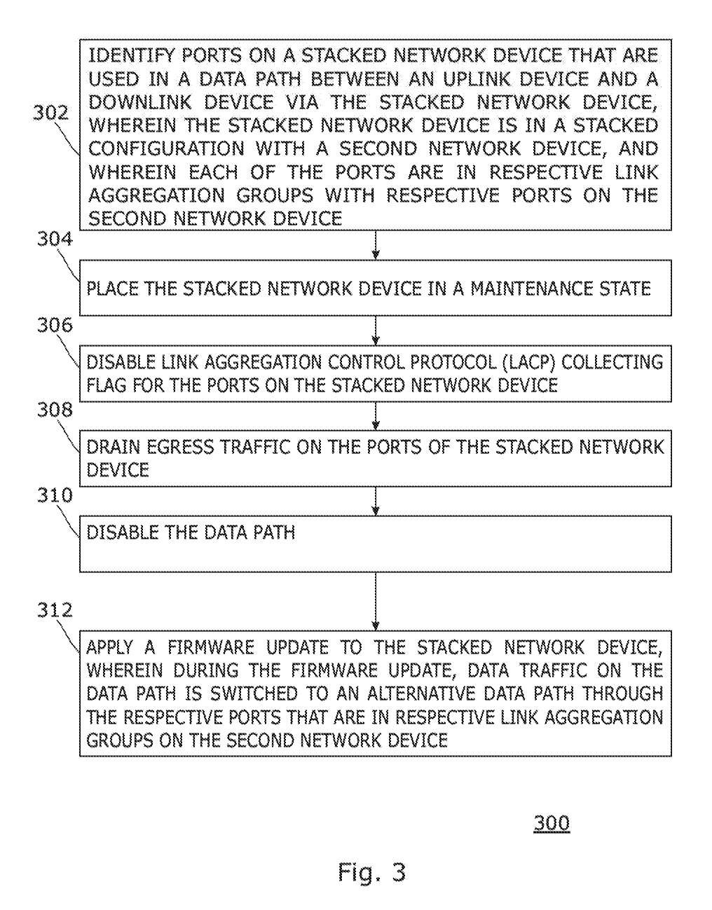

FIG. 3 is a block diagram of an example method 300 for performing a firmware update in a stacked network device. The method 300, which is described below, may be partially executed on a computing device such as management system 116 of FIG. 1 or system 200 of FIG. 2. However, other suitable computing devices may execute method 300 as well. At block 302, ports on a stacked network device that are used in a data path between an uplink device and a downlink device via the stacked network device may be identified, for example, by identification engine 122. The stacked network device may be in a stacked configuration with a second network device. Each of the identified ports may be in respective link aggregation groups with respective ports on the second network device. At block 304, identification engine 122 may place the stacked network device in a maintenance state. At block 306, Link Aggregation Control Protocol (LACP) collecting flag may be disabled for the identified ports on the stacked network device, for example, by status engine 124. At block 308, egress traffic on the ports of the stacked network device may be drained, for example, by traffic engine 126. At block 310, the data path may be switched over and disabled, for example, by traffic engine 126. At block 312, a firmware update may be applied to the stacked network device in the maintenance state, for example, by update engine 128. In an example, during the firmware update, data traffic on the data path may be switched to an alternate data path through the respective ports that are in respective link aggregation groups on the second network device.

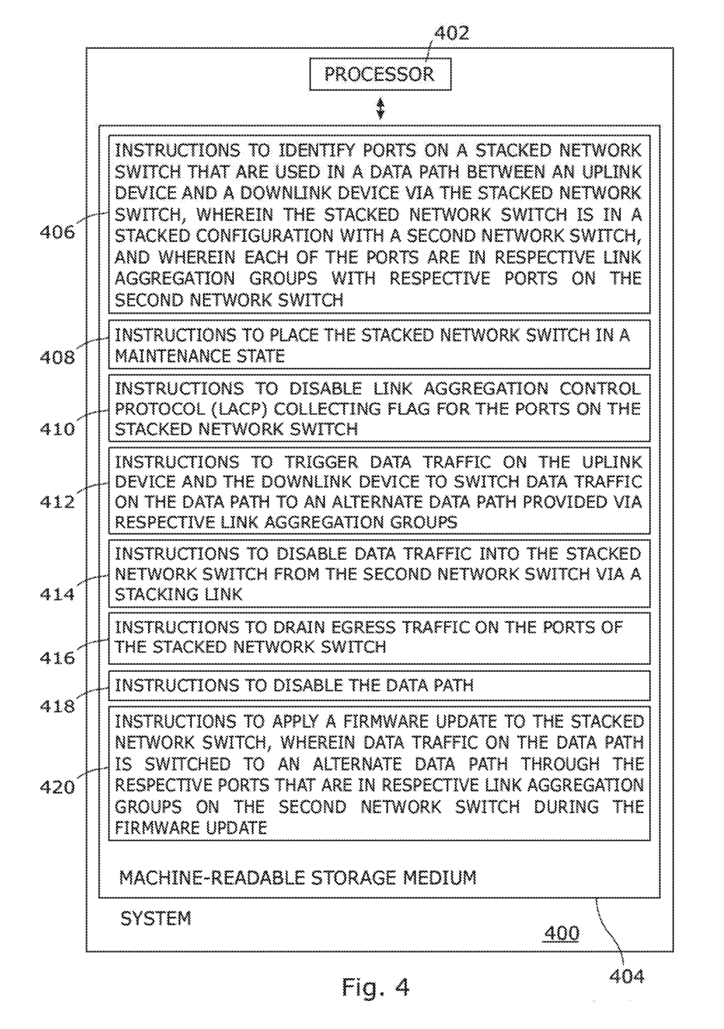

FIG. 4 is a block diagram of an example system 400 including instructions in a machine-readable storage medium for performing a firmware update in a stacked network device. System 400 includes a processor 402 and a machine-readable storage medium 404 communicatively coupled through a system bus. In an example, system 400 may be analogous to management system 116 of FIG. 1, system 200 of FIG. 2. Processor 402 may be any type of Central Processing Unit (CPU), microprocessor, or processing logic that interprets and executes machine-readable instructions stored in machine-readable storage medium 404. Machine-readable storage medium 404 may be a random access memory (RAM) or another type of dynamic storage device that may store information and machine-readable instructions that may be executed by processor 402. For example, machine-readable storage medium 404 may be Synchronous DRAM (SDRAM), Double Data Rate (DDR), Rambus DRAM (RDRAM), Rambus RAM, etc. or storage memory media such as a floppy disk, a hard disk, a CD-ROM, a DVD, a pen drive, and the like. In an example, machine-readable storage medium may be a non-transitory machine-readable medium. Machine-readable storage medium 404 may store instructions 406, 408, 410, 412, 414, 416, 418, and 420. In an example, instructions 406 may be executed by processor 402 to identify ports on a stacked network device (for example, a network switch) that are used in a data path between an uplink device and a downlink device via the stacked network device. The stacked network device may be in a stacked configuration with a second network device. Each of the ports may be in respective link aggregation groups with respective ports on the second network device. Instructions 408 may be executed by processor 402 to place the stacked network device in a maintenance mode. In the maintenance mode, instructions 410 may be executed by processor 402 to disable Link Aggregation Control Protocol (LACP) collecting flag for the ports on the stacked network device.

Instructions 412 may be executed by processor 402 to trigger data traffic on the uplink device and the downlink device to switch data traffic on the data path to an alternate data path provided via respective link aggregation groups. Instructions 414 may be executed by processor 402 to disable data traffic into the stacked network device from the second network device via a stacking link. Instructions 416 may be executed by processor 402 to drain egress traffic on the ports of the stacked network device. Instructions 418 may be executed by processor 402 to disable the data path. Instructions 420 may be executed by processor 402 to apply a firmware update to the stacked network device, wherein data traffic on the data path is switched to an alternate data path through the respective ports that are in respective link aggregation groups on the second network device during the firmware update.

For the purpose of simplicity of explanation, the example method of FIG. 3 is shown as executing serially, however it to be understood and appreciated that the present and other examples are not limited by the illustrated order. The example systems of FIGS. 1, 2 and 4, and method of FIG. 3 may be implemented in the form of a computer program product including computer-executable instructions, such as program code, which may be run on any suitable computing device to conjunction with a suitable operating system (for example, Microsoft Windows, Linux, UNIX, and the like). Examples within the scope of the present solution may also include program products comprising non-transitory computer-readable media for carrying or having computer-executable instructions or data structures stored thereon. Such computer-readable media can be any available media that can be accessed by a general purpose or special purpose computer. By way of example such computer-readable media can comprise RAM, ROM, EPROM, EEPROM, CD-ROM, magnetic disk storage or other storage devices, or any other medium which can be used to carry or store desired program code m the form of computer-executable instructions and which can be accessed by a general purpose or special purpose computer. The computer readable instructions can also be accessed from memory and executed by a processor.

It should be noted that the above-described examples of the present solution is for the purpose of illustration only. Although the solution has been described in conjunction with a specific example thereof, numerous modifications may be possible without materially departing from the teachings and advantages of the subject matter described herein. Other substitutions, modifications and changes may be made without departing from the spirit of the present solution. All of the features disclosed in this specification (including any accompanying claims, abstract and drawings), and/or all of the steps of any method or process so disclosed, may be combined in any combination, except combinations where at least some of such features and/or steps are mutually exclusive.

1. A method comprising:
identifying ports on a stacked network device that are used in a data path between an uplink device and a downlink device via the stacked network device, wherein the stacked network device is in a stacked configuration with a second network device, and wherein each of the ports are in respective link aggregation groups with respective ports on the second network device;
placing the stacked network device in a maintenance state, wherein in the maintenance state:
disabling Link Aggregation Control Protocol (LACP) collecting flag for the ports on the stacked network device;
draining egress traffic on the ports of the stacked network device;
disabling the data path; and
applying a firmware update to the stacked network device, wherein during the firmware update, data traffic on the data path is switched to an alternate data path through the respective ports that are in respective link aggregation groups on the second network device.

2. The method of claim 1, further comprising:
triggering data traffic on the uplink device and the downlink device to switch data traffic on the data path to the alternate data path provided via respective link aggregation groups.

3. The method of claim 1, further comprising:
disabling data traffic into the stacked network device from the second network device via a stacking link.

4. The method of clam 1, wherein the respective link aggregation groups include an active/active link aggregation group comprising ports on the uplink device a port on the stacked network device, and a port on the second network device.

5. The method of claim 1, wherein the respective link aggregation groups include an active/active link aggregation group comprising ports on the downlink device, a port on the stacked network device, and a port on the second network device.

6. The method of claim 1, further comprising:
initiating a reboot of the stacked network device; and
maintaining the LACP collecting flag for the ports on the stacked network device in a disabled state during the reboot.

7. The method of claim 6, further comprising:
in response to a determination that the reboot of the stacked network device is complete, enabling LACP collecting flag for the ports on the stacked network device.

8. A system comprising:
an identification engine to identify ports on a stacked network device that are used in a data path between an uplink device and a downlink device via the stacked network device, wherein the stacked network device is in a stacked configuration with a second network device, and wherein each of the ports are in respective link aggregation groups with respective ports on the second network device;
the identification engine to place the stacked network device in a maintenance state, wherein in the maintenance state:
a status engine to disable Link Aggregation Control Protocol (LACP) collecting flag for the ports on the stacked network device;
a traffic engine to drain egress traffic on the ports of the stacked network device;
the traffic engine to disable the data path; and
an update engine to apply a firmware update to the stacked network device, wherein data traffic on the data path is switched to an alternate data path through the respective ports that are in respective link aggregation groups on the second network device during the firmware update.

9. The system of claim 8, wherein the stacked network device is a virtual connect device, the uplink device is top-of-rack network switch, and the downlink device is a blade server.

10. The system of claim 8, wherein a port among the ports on the stacked network device is in an active/passive aggregation group with the uplink device and a port of the second network device.

11. The system of claim 8, wherein a port among the ports on the stacked network device is in an active/passive link aggregation group with the downlink device and a port of the second network device.

12. The system of claim 8, wherein the uplink device a top-of-rack network switch.

13. The system of claim 8, wherein the ports on the second network device is one of physical port or a virtual port.

14. The system of claim 8, wherein the downlink device is a server.

15. The system of claim 8, wherein the ports on the stacked network device is one of a physical port or a virtual port.

16. A non-transitory machine-readable storage medium comprising instructions, the instructions executable by a processor to:
identify ports on a stacked network switch that are used in a data path between an uplink device and a downlink device via the stacked network switch wherein the stacked network switch is in a stacked configuration with a second network switch, and wherein each of the ports are in respective link aggregation groups with respective ports on the second network switch;
place the stacked network switch in a maintenance state, wherein in the maintenance state;
disable Link Aggregation Control (LACP) collecting flag for the ports the stacked network switch;
trigger data traffic on the uplink device and the downlink device to switch data traffic on the data path to an alternate data path provided via respective link aggregation groups;
disable data traffic into the stacked network switch from the second network switch via a stacking link;
drain egress traffic on the ports of the stacked network switch;
disable the data path; and
apply a firmware update to the stacked network switch, wherein data traffic on the data path is switched to an alternate data path through the respective ports that are in respective link aggregation groups on the second network switch during the firmware update.

17. The storage medium of claim 16, further comprising instructions to:
initiate a reboot of the stacked network switch; and
maintain the LACP collecting flag for the ports on the stacked network switch in a disabled state during the reboot.

18. The storage medium of claim 17, wherein the instructions to maintain comprise instructions to:
refer to a configuration file that stores information related to a disabled state of the LACP collecting flag for the ports on the stacked network switch in response to the disabling of the LACP collecting flag for the ports.

19. The storage medium of claim 17, further comprising instructions to:
in response to a determination that the reboot of the stacked network switch is complete, enable LACP collecting flag for the ports on the stacked network switch.

20. The storage medium of claim 16, further comprising instructions to:
store information related to a disabled state of the LACP collecting flag for the ports on the network switch in a configuration file in response to the disabling of the LACP collecting flag for the ports.
